(19) United States
(12) Patent Application Publication
(10) Pub. No.: US 2015/0365893 A1
(43) Pub. Date: Dec. 17, 2015

(54) WIRELESS COMMUNICATION APPARATUS AND COMMUNICATION SYSTEM

(71) Applicant: SHARP KABUSHIKI KAISHA, Osaka (JP)

(72) Inventors: Yuichi NOBUSAWA, Osaka-shi (JP); Shuichi TAKEHANA, Osaka-shi (JP); Toshiaki KAMENO, Osaka-shi (JP); Hidenobu FUKUMASA, Osaka-shi (JP); Shusaku FUKUMOTO, Osaka-shi (JP)

(21) Appl. No.: 14/763,240

(22) PCT Filed: Feb. 13, 2014
(86) PCT No.: PCT/JP2014/053337

§ 371 Date: Jul. 24, 2015

(30) Foreign Application Priority Data
Mar. 8, 2013 (JP) 2013-046981

(51) Int. Cl. H04W 52/02

(52) U.S. Cl. CPC H04W 52/0209

(57) ABSTRACT

A wireless communication apparatus obtains information on a communication performance when selecting a power saving mode. A wireless communication apparatus performing communication while selecting a power saving mode (power efficient) in which a power consumption is small or an operation mode (for example, normal mode: normal) other than the power saving mode, includes: a communication control part 32 that acquires power saving operation parameters in a case of operating in the power saving mode; and a power saving control part 33 that determines whether or not the acquired power saving operation parameters fulfill allowable parameters of its own apparatus in a case of operating in the power saving mode, selects any of operation modes in accordance with the determination result, and transmits information indicating the selected operation mode.

### TECHNICAL FIELD

The present invention relates to a wireless communication apparatus and a communication system which perform communication while selecting a power saving mode where power consumption is small or an operation mode other than the above power saving mode.

### BACKGROUND ART

In the past, communication performance of a communication system has been set usually for convenience of a network (NW) side without taking into consideration a situation of a wireless communication terminal (UE: User Equipment) side except capabilities of the UE. However, with such a method of setting the communication performance, the communication performance having an excessive quality for the UE side may have been set, and a case where more communication lines than necessary are allocated may have been generated. As the result, there has been a case where a power consumption of UE has been increased. In order to cope with such a problem, in standardization of 3GPP Release 11, it has been agreed that PPI (Power Preference Indication) is transmitted to NW from UE to allow change of performances such as a communication response in accordance with power-saving of UE.

Here, “PPI” means a report for the purpose of notifying NW of an operation mode which UE has selected preferentially from two operation modes that are a normal mode (normal) and a power saving mode (power efficient). It becomes possible for NW to perform an operation while setting usual parameters to UE which has selected PPI as “normal”, and performs an operation while setting parameters of power-saving to UE which has selected PPI as “power efficient”.

### CITATION LIST

### Non-Patent Literature

Non-patent literature 1: 3GPP TSG RAN WG2 79 Report

### DISCLOSURE OF THE INVENTION

### Problem to be Solved by the Invention

However, in the agreement of 3GPP Release 11, a response of NW which has received PPI and contents of change of a communication performance at the time of a power saving mode have not been defined as a standard, and therefore, contents of change of a communication performance at the time of a power saving mode may be different for every NW. That is, since actions at the time of the power saving mode (contents of change of the communication performance) are not standardized, UE cannot acquire information on a communication performance when selecting a new operation mode (power efficient), and cannot select PPI correctly. Therefore, a scheme in which UE can acquire information which will be a determination criterion when selecting PPI is desired.

The present invention is made in view of such a situation, and aims at providing a wireless communication apparatus and a communication system which can obtain information on a communication performance at the time of having selected a power saving mode (power efficient).

### Means for Solving the Problems

For the purpose of attaining the above object, the present invention has taken the following measures. That is, the wireless communication apparatus of the present invention is a wireless communication apparatus that performs communication while selecting a power saving mode in which a power consumption is small or an operation mode other than the power saving mode, and includes: a communication interface to acquire power saving operation parameters in a case of operating in a power saving mode; a control part to determine whether or not the acquired power saving operation parameters fulfill allowable parameters of its own apparatus in a case of operating in the power saving mode, and to select any of operation modes in accordance with the determination result; and an operation mode notifying part to transmit information indicating the selected operation mode.

In this way, the wireless communication apparatus acquires power saving operation parameters in a case of operating in the power saving mode, and determines whether or not the acquired power saving operation parameters fulfill allowable parameters of its own apparatus in a case of operating in the power saving mode, and selects any of operation modes in accordance with the determination result, and therefore, it becomes possible to select PPI correctly. As the result, when the wireless communication apparatus selects a power saving mode (power efficient), it becomes possible to avoid a communication performance deterioration which is not intended.

### Effect of the Invention

According to the present invention, it becomes possible to select PPI (Power Preference Indication) appropriately.

### BRIEF DESCRIPTION OF THE DRAWINGS

FIG. 1 illustrates a schematic configuration of a communication system according to a first embodiment;

FIG. 2 illustrates a schematic configuration of UE;

FIG. 3 is a sequence chart illustrating an example of an operation of the communication system according to the first embodiment;

FIG. 4 illustrates a screen display example of UE; and

FIG. 5 is a sequence chart illustrating an example of an operation of a communication system according to a second embodiment.

### BEST MODES FOR CARRYING OUT THE INVENTION

### First Embodiment

Hereinafter, an embodiment of the present invention will be described with reference to drawings. In a communication system according to the present embodiment, NW (Network) informs UE (User Equipment) of operation parameters of NW as System Information at the time of a power saving mode (power efficient). UE receives the System Information, and determines a transmission content of PPI by using operation parameters of the power saving mode, and performs transmission of PPI.

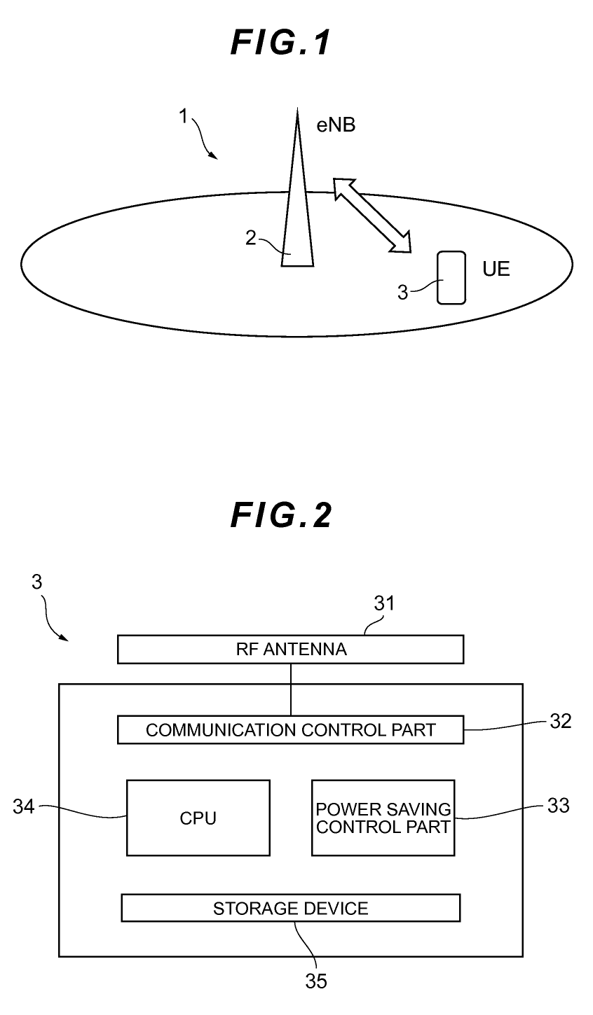

FIG. 1 illustrates a schematic configuration of the communication system according to the present embodiment. This communication system 1 includes eNB (evolved NodeB) 1 as a base station apparatus, and UE (User Equipment) 3 as a wireless communication apparatus.

The eNB2 and UE3 can perform a communication by 3G (3rd Generation), and a communication by LTE (Long Term Evolution) in a switching manner.

FIG. 2 illustrates a schematic configuration of UE3. UE3 performs communication while selecting a power saving mode in which power consumption is small, or an operation mode other than the power saving mode, i.e., a normal mode. UE3 carries out transmission/reception of a wireless signal in a communication control part 32 via an RF antenna 31. The RF antenna 31 and the communication control part 32 constitute a communication interface. A CPU 34 controls an operation of the entire apparatus. A power saving control part 33 functions as a control part, and determines whether or not power saving operation parameters acquired from NW fulfill allowable parameters of its own apparatus in a case of operating in the power saving mode. Then, any of operation modes is selected in accordance with the determination result. A storage device 35 stores power saving operation parameters acquired from NW.

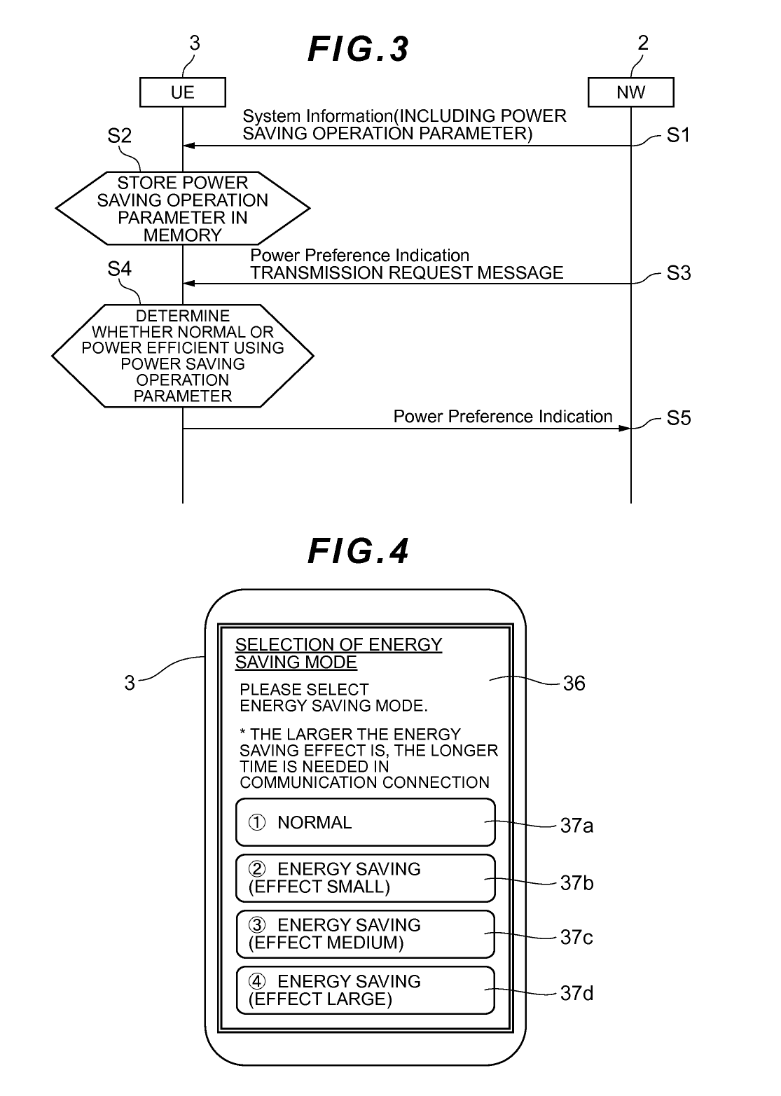

FIG. 3 is a sequence chart illustrating an example of an operation of the communication system according to the present embodiment. Here, description will be given with eNB2 as NW. First, NW2 informs UE3 of power saving operation parameters as System Information (Step S1). The power saving operation parameters are operation parameters of NW2 at the time of operating UE3 in the power saving mode. The power saving operation parameters can be configured by ones indicated in the following table, for example.

TABLE 1

| | Power saving operation |
|---|---|
| Item | value |
| LTE Connected DRX cycle | 5.12 seconds |
| Paging cycle | 2.56 seconds |
| Periodic Routing Area Update cycle | 54 minutes |

In the above table 1, “LTE Connected DRX (Discontinuous Reception) cycle” denotes a reception cycle at the time of receiving transmit information from NW2 periodically. The longer this reception cycle becomes, the smaller the power consumption becomes. A numerical value of “Power saving operation value (right-hand side of the table)” denotes that UE3 performs a periodic receiving operation of “LTE Connected DRX” at a cycle of 5.12 seconds at the time of a power saving mode. In addition, “Paging cycle” denotes a reception cycle at the time of receiving periodically confirmation (Paging) of a call such as incoming phone call from NW2. The longer the reception cycle becomes, the smaller the power consumption becomes. A number of “Power saving operation value (right-hand side of the table)” denotes that UE3 performs a receiving operation of Paging at a cycle of 2.56 seconds at the time of a power saving mode. In addition, “Periodic Routing Area Update cycle” is a transmission cycle at the time of notifying NW2 of a location of UE3 periodically (periodic location registration). The longer the transmission cycle becomes, the smaller the power consumption becomes. A number of “Power saving operation value (right-hand side of the table)” denotes that UE3 performs location registration at a cycle of 54 minutes at the time of a power saving mode.

In FIG. 3, UE3 receives power saving operation parameters from NW2 as System Information, and stores them in a memory (Step S2). Next, NW2 requests UE3 to transmit PPI (Step S3). A request for transmission of PPI by NW2 at this time is referred to as a “PPI transmission request message”. UE3 determines whether or not power saving operation parameters received at Step S1 fulfill “UE allowable parameters” of its own apparatus in accordance with a determination method described in the following, and determines the content of PPI as “normal” or “power efficient” (Step S4).

The UE allowable parameter is the allowable parameter at the time of a power saving operation in UE. The UE allowable parameters can be configured by ones indicated in the following table, for example.

TABLE 2

| Item | Allowable value |
|---|---|
| LTE Connected DRX cycle | 6 seconds or less |
| Paging cycle | 3 seconds or less |
| Periodic Routing Area Update cycle | 120 minutes or less |

In Table 2, a content of each item is the same as that of descriptions of Table 1. The numerical value shown in “power saving operation value (right-hand side of the table)” indicates that in the case of “LTE Connected DRX cycle”, the operation cycle of 6 seconds or less is allowable. In addition, it indicates that in the case of “Paging cycle”, the operation cycle of 3 seconds or less is allowable. It indicates that in the case of “Periodic Routing Area Update cycle”, the operation of 120 minutes or less is allowable. This parameter is usually set as an initial value in advance by a maker, a chip vendor or a carrier. In addition, a user may also perform modification.

Next, a determination method in Step S4 will be described. UE3 determines whether the power saving operation parameters indicated in the above table 1 fulfill the UE allowable parameters indicated in Table 2, and determines a content of PPI, i.e., whether to set it as “Normal” or “Power efficient”. In an example illustrated in the present embodiment, the parameters are determined as follows:
LTE Connected DRX cycle; 5.12 seconds<6 seconds.
Paging cycle; 2.56 seconds<3 seconds.
Periodic Routing Area Update cycle; 54 minutes<120 minutes.
   That is, since the power saving parameters fulfill conditions of the UE allowable parameters in all the items, the content of PPI is determined as “Power efficient”. Supposedly, when at least one item is not fulfilled, the content of PPI is determined as “normal”.

In FIG. 3, UE3 transmits PPI of “normal” or “power efficient” to NW2 based on the content determined above (Step S5). When “System Information” is received again, or when a user performs mode change, e.g. change from a normal mode to a power saving mode, the process returns to Step S4, where determination of PPI is performed.

As described above, according to the present embodiment, NW2, while notifying UE3 of action contents at the time of PPI reception in advance, provides a reference for the purpose of selecting PPI of either “normal” mode or “power efficient” mode, and thereby, UE3 comes to be able to select PPI correctly, and by having selected “power efficient” mode, it is possible to avoid a communication performance deterioration which is not intended by UE3.

### [Modification Example of First Embodiment]

Next, a modification example of the first embodiment will be described. Here, a case where a user changes UE allowable parameters will be illustrated. FIG. 4 illustrates a screen display example of UE. UE3 is provided with a display 36, where a variety of information can be displayed. In FIG. 4, a selection screen of the power saving mode (energy saving mode) is displayed. In FIG. 4, a normal mode selection button 37a, an energy saving (effect small) mode selection button 37b, an energy saving (effect medium) mode selection button 37c and an energy saving (effect large) mode selection button 37d are displayed, and configured to make a user select the operation mode of UE3.

Here, “the energy saving (effect small) mode selection button 37b, the energy saving (effect medium) mode selection button 37c and the energy saving (effect large) mode selection button 37d” which are shown in FIG. 4 correspond to UE allowable parameters. For example, when a user manipulates the energy saving (effect medium) mode selection button 37c in selection of an energy saving mode, each parameter of the energy saving (effect medium) indicated in the following table 3 is set as allowable parameters of UE3.

TABLE 3

| | | Energy saving | |
|---|---|---|---|
| | Energy saving | (effect | Energy saving |
| Item | (effect small) | medium) | (effect large) |
| LTE | 6 seconds or | 8 seconds or | 10 seconds or |
| Connected | less | less | less |
| DRX cycle | | | |
| Paging cycle | 3 seconds or | 6 seconds or | 9 seconds or |
| | less | less | less |
| Periodic | 120 minutes or | 200 minutes or | 200 minutes or |
| Routing Area | less | less | less |
| Update cycle | | | |
| Periodic | 120 minutes or | 200 minutes or | 200 minutes or |
| Tracking | less | less | less |
| Area Update | | | |
| cycle | | | |
| RAT | LTE/WCDMA/ | LTE/WCDMA | WCDMA |
| restriction | GSM | | |
| CELL_DCH | 10 seconds or | 5 seconds or | 2 seconds or |
| state | more | more | more |
| maintaining | | | |
| time | | | |
| CELL_FACH | 15 seconds or | 10 seconds or | 5 seconds or |
| state | more | more | more |
| maintaining | | | |
| time | | | |
| LTE | 2 minutes or | 1 minute or | 30 seconds or |
| Connected | more | more | more |
| state | | | |
| maintaining | | | |
| time | | | |
| Communication | 50 Mbps or less | 1 Mbps or less | 100 kbps or less |
| speed | | | |
| restriction | | | |
| Bandwidth | 100 MHz or less | 20 MHz or less | 5 MHz or less |
| restriction | | | |
| Restriction | 4 or less | 2 or less | 1 or less |
| of the number | | | |
| of antennas | | | |
| Availability | available | not available | not available |
| restriction | | | |
| of Carrier | | | |
| Aggregation | | | |

In Table 3, “Periodic Tracking Area Update Cycle” is a transmission cycle at the time of notifying NW of a location of UE periodically (periodic location registration) in NW of LTE. The longer the transmission cycle becomes, the smaller the power consumption becomes. In addition, “RAT restriction” performs restriction of available “Radio Access Technology (RAT)” such as LTE, WCDMA (registered trademark) and GSM (registered trademark). For example, at the time of the energy saving (effect small), LTE/WCDMA (registered trademark)/GSM (registered trademark) are made available, and at the time of the energy saving (effect large), only WCDMA(registered trademark) is made available.

In addition, “CELL_DCH state maintaining time” performs restriction of a time until shifting to a CELL_FACH state from a CELL_DCH state in UE connected with NW by WCDMA (registered trademark). Since the CELL_DCH state has a large electric current, the shorter the maintaining time is, the smaller the electric current becomes. In addition, “CELL_FACH state maintaining time” performs restriction of a time until shifting to a CELL_PCH state from a CELL_FACH state in UE connected with NW by WCDMA (registered trademark). Since the CELL_FACH state has a large electric current, the shorter the maintaining time is, the smaller the electric current becomes.

In addition, “LTE Connected state maintaining time” performs restriction of a time until shifting to an “Idle state” from a “Connected state” in UE connected with NW by LTE. Since the “Connected state” has a large electric current, the shorter the maintaining time is, the smaller the electric current becomes. In addition, “communication speed restriction” restricts a communication speed. Since a consumed electric current becomes higher at the time of a higher communication speed than at the time of a lower communication speed, the communication speed is set in order to reduce the electric current.

In addition, “bandwidth restriction” performs restriction of an available bandwidth. The narrower the bandwidth to be used is, the smaller the consumed electric current becomes. In addition, “restriction of the number of antennas” performs restriction of the number of available antennas of UE. The fewer the number of available antennas are, the smaller the electric current becomes. In addition, “availability restriction of Carrier Aggregation” restricts availability of Carrier Aggregation, and suppresses the consumed electric current.

With this configuration, it becomes possible to realize change of a UE allowable parameter in accordance with a selection operation of a user.

### Second Embodiment

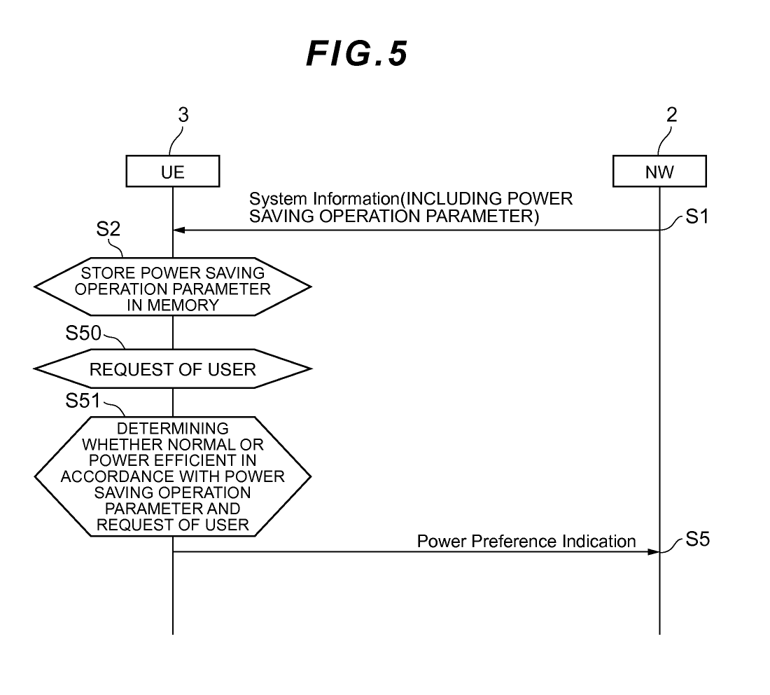

FIG. 5 is a sequence chart illustrating an example of an operation of a communication system according to a second embodiment. In the second embodiment, information (PPI) indicating an operation mode is transmitted spontaneously by a request from a user. In FIG. 5, in the same way as the first embodiment, description will be given with eNB2 as NW. In addition, the same step number is assumed to be given for the same operation. First, NW2 informs UE3 of power saving operation parameters as System Information (Step S1). Next, UE3 receives power saving operation parameters from NW2 as System Information, and stores them in a memory (Step S2).

Next, when there is an operation of requesting transmission of information indicating an operation mode from a user (Step S50), it is determined whether a content of PPI is made to be as “normal” or as “power efficient” in accordance with the power saving operation parameters and the request of a user (Step S51). Then, PPI in accordance with the result of determination is transmitted to NW2 (Step S5). Thereby, even when there is not “PPI transmission request message” from the network, it becomes possible to transmit PPI spontaneously from the terminal side.

The wireless communication apparatus according to the present invention can take the following aspects. That is, (1) the wireless communication apparatus of the present invention is a wireless communication apparatus that performs communication while selecting a power saving mode in which a power consumption is small or an operation mode other than the power saving mode, and includes: a communication interface to acquire power saving operation parameters in a case of operating in a power saving mode; a control part to determine whether or not the acquired power saving operation parameters fulfill allowable parameters of its own apparatus in a case of operating in the power saving mode, and to select any of operation modes in accordance with the determination result; and an operation mode notifying part to transmit information indicating the selected operation mode.

In this way, the wireless communication apparatus acquires power saving operation parameters in a case of operating in the power saving mode, and determines whether or not the acquired power saving operation parameters fulfill allowable parameters of its own apparatus in a case of operating in the power saving mode, and selects any of operation modes in accordance with the determination result, and therefore, it becomes possible to select PPI correctly. As the result, when the wireless communication apparatus selects a power saving mode (power efficient), it becomes possible to avoid a communication performance deterioration which is not intended.

(2) In addition, in the wireless communication apparatus of the present invention, when having received a message requesting transmission of information indicating any of operation modes or when there is an operation of requesting transmission of information indicating an operation mode from a user, the operation mode notifying part transmits information indicating the operation mode which the control part has selected.

In this way, when having received a message requesting transmission of information indicating any of operation modes or when there is an operation of requesting transmission of information indicating an operation mode from a user, the operation mode notifying part transmits information indicating an operation mode which the control part has selected, and therefore, when there is a request from the network side, and when there is a request from a user, it becomes possible to carry out notification of an operation mode. Thereby, selection of PPI can be performed correctly, and it becomes possible to avoid a communication performance deterioration which is not intended.

(3) In addition, in the wireless communication apparatus of the present invention, the control part, when having reacquired power saving operation parameters, or when a user changes an operation mode, determines again whether or not the power saving operation parameters fulfill the allowable parameters.

In this way, the control part, when having reacquired power saving operation parameters, or when a user changes an operation mode, determines again whether or not the power saving operation parameters fulfill the allowable parameters, and therefore, it becomes possible to perform determination using the newest power saving operation parameters at all times.

(4) In addition, in the wireless communication apparatus of the present invention, the control part, when a user has changed the allowable parameters, determines again whether or not the power saving operation parameters fulfill the changed allowable parameters.

In this way, the control part, when a user has changed the allowable parameters, determines again whether or not the power saving operation parameters fulfill the changed allowable parameters, and therefore, it becomes possible to select an operation mode in accordance with an operation of a user.

(5) In addition, the communication system of the present invention is a communication system that includes a wireless communication apparatus described in any of the above (1) to (4) and a base station apparatus, wherein the base station apparatus transmits power saving operation parameters in a case where the wireless communication apparatus operates in a power saving mode to the wireless communication apparatus, and the wireless communication apparatus determines whether or not the power saving operation parameters fulfill allowable parameters of its own apparatus in a case of operating in the power saving mode, and selects any of operation modes in accordance with the determination result, and transmits information indicating the selected operation mode to the base station apparatus.

In this way, the base station apparatus transmits power saving operation parameters in a case where the wireless communication apparatus operates in the power saving mode to the wireless communication apparatus, and the wireless communication apparatus determines whether or not the power saving operation parameters fulfill allowable parameters of its own apparatus in a case of operating in the power saving mode, and selects any of operation modes in accordance with the determination result, and transmits information indicating the selected operation mode to the base station apparatus, and therefore, the wireless communication apparatus comes to be able to select PPI correctly. As the result, when the wireless communication apparatus selects a power saving mode (power efficient), it becomes possible to avoid a communication performance deterioration which is not intended.

### DESCRIPTION OF SYMBOLS

1 Communication system
2 eNB
3 UE
31 RF antenna
32 Communication control part
33 Power saving control part
35 Storage device
36 Display
37a Normal mode selection button
37b Mode selection button
37c Mode selection button
37d Mode selection button

1. A wireless communication apparatus that performs communication while selecting a power saving mode in which a power consumption is small or an operation mode other than said power saving mode, said apparatus comprising:
a communication interface to acquire power saving operation parameters in a case of operating in the power saving mode;
a control part to determine whether or not said acquired power saving operation parameters fulfill allowable parameters of its own apparatus in a case of operating in the power saving mode, and to select any of operation modes in accordance with said determination result; and
an operation mode notifying part to transmit information indicating said selected operation mode.

2. The wireless communication apparatus according to claim 1, wherein
when a message requesting transmission of information indicating any of operation modes is received, or when there is an operation of requesting transmission of information indicating an operation mode from a user, said operation mode notifying part transmits information indicating an operation mode which said control part has selected.

3. The wireless communication apparatus according to claim 1, wherein
said control part, in a case of having reacquired the power saving operation parameters or in a case where a user has changed the operation mode, determines again whether or not said power saving operation parameters fulfill said allowable parameters.

4. The wireless communication apparatus according to claim 1, wherein
said control part, in a case where a user has changed said allowable parameters, determines again whether or not said power saving operation parameters fulfill said changed allowable parameters.

5. A communication system that includes a wireless communication apparatus according to claim 1 and a base station apparatus, wherein
said base station apparatus transmits power saving operation parameters in a case where said wireless communication apparatus operates in the power saving mode to said wireless communication apparatus, and
said wireless communication apparatus determines whether or not said power saving operation parameters fulfill allowable parameters of its own apparatus in a case of operating in the power saving mode, selects any of operation modes in accordance with said determination result, and transmits information indicating said selected operation mode to said base station apparatus.
